(19) United States
(12) Patent Application Publication
(10) Pub. No.: US 2020/0062993 A1
(43) Pub. Date: Feb. 27, 2020

(54) UNIFORM FILM COATING COMPOSITION FOR LOW TEMPERATURE REMOVABILITY

(71) Applicant: Groco Specialty Coatings, Co., Dallas, TX (US)

(72) Inventors: George W. Grogan, Dallas, TX (US); Robert H. Boyd, Dallas, TX (US)

(21) Appl. No.: 16/107,150

(22) Filed: Aug. 21, 2018

(51) Int. Cl. C09D 175/04; C09D 5/20; C09D 7/44

(52) U.S. Cl. CPC C09D 175/04; C08L 31/04; C09D 7/44; C09D 5/20

(57) ABSTRACT

A method of preparing a coating composition that comprises a mixture that includes a releasing agent, thickening agents, vinyl acetate-acrylic copolymer and a urethane, which provides the film with good flexibility even at lower temperatures. This film may be applied to a surface to protect it from the elements and physical damage.

### TECHNICAL FIELD

This application relates to a polymer-based removable film coating mixtures containing a urethane that remains flexible at low temperatures.

### BACKGROUND

Various film coating compositions are often applied to the outer surfaces of manufactured products so as to protect the product from damage during further processing and/or transportation. The film coating should be easily and uniformly applied to only the desired surfaces of the product, that is, without overspray or sagging of the applied coating composition, even on vertically oriented surfaces, before the composition sets to form a film. The film coating should also be easily removed.

### SUMMARY

One embodiment is a method of preparing a coating composition. The method comprises preparing a mixture that includes a releasing agent, thickening agents, vinyl acetate-acrylic copolymer, and a urethane.

Another embodiment is a method of forming a film, comprising, providing a coating composition that includes a releasing agent, a thickening agent, a vinyl acetate-acrylic copolymer and a urethane. The method also comprises applying the coating composition to a surface.

Another embodiment is a protective coating. The protective coating comprises a film applied to a surface of a manufactured product. The film including a coating composition that includes a releasing agent, a thickening agent, a vinyl acetate-acrylic copolymer and a urethane.

### BRIEF DESCRIPTION OF THE DRAWINGS

Reference is now made to the following descriptions taken in conjunction with the accompanying drawings, in which:

FIG. 1 presents a flow diagram of a method of preparing a coating composition;

FIG. 1A presents another flow diagram of the method of preparing embodiments of the coating composition;

FIG. 2 presents a flow diagram of an example method of applying a coating composition, such as any of the coating compositions formed from the method described in the content of FIGS. 1-1A, to form a film;

FIG. 3 presents a schematic view of a protective coating that comprises a film of the coating composition, such as any of the coating compositions described in the context of FIG. 1-2.

### DETAILED DESCRIPTION

The term, “or,” as used herein, refers to a non-exclusive or, unless otherwise indicated. Also, the various embodiments described herein are not necessarily mutually exclusive, as some embodiments can be combined with one or more other embodiments to form new embodiments. As used herein and in the claims, the term “about” includes values within ±5% for values stated above 100 and ±20% for values stated below 100.

Embodiments of the present disclosure benefit from the recognition that the addition of a urethane in the disclosed coating composition provides a film coating that stays flexible at low temperatures. As used herein and in the claims “low temperatures” means temperatures that range from about 0° C. to about −20° C. Additionally, the urethane does not hinder the films other components that provide a mixture that facilitates the uniform application of the coating to form a film without overspray or sagging of the applied coating composition, regardless of whether the coating is applied to a vertical surface or horizontal surface (e.g., perpendicular or parallel to the earth's surface, respectively). The coating formulations as provided by embodiments of this disclosure can be applied by extrusion processes. The purpose of extrusion application of the coating to be provide an application method that does not create overspray or require masking of the product to which the coating is applied. Also, extrusion application provides a cleaner, more acceptable work environment having no spray dust, making this application more cost effective for large productions. The choices of the thickening agents and their amounts in the coating composition help control the coating's viscosity. Consequently, the particular combinations of the components in the coating compositions disclosed herein provide films with surprisingly strong and uniform thickness and remain flexible at low temperatures. Surprisingly, these films can be readily removed from a surface being protected.

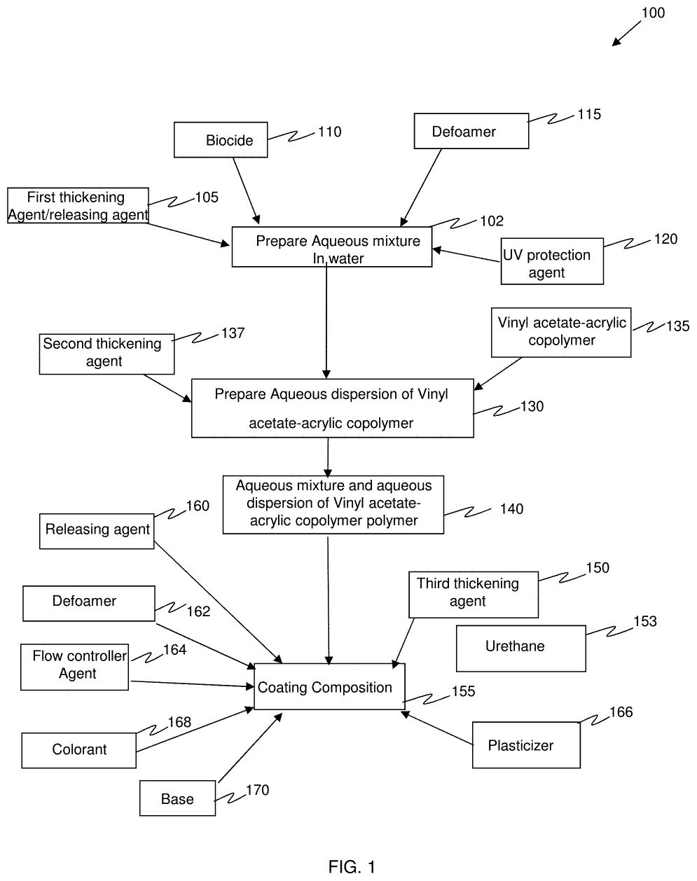

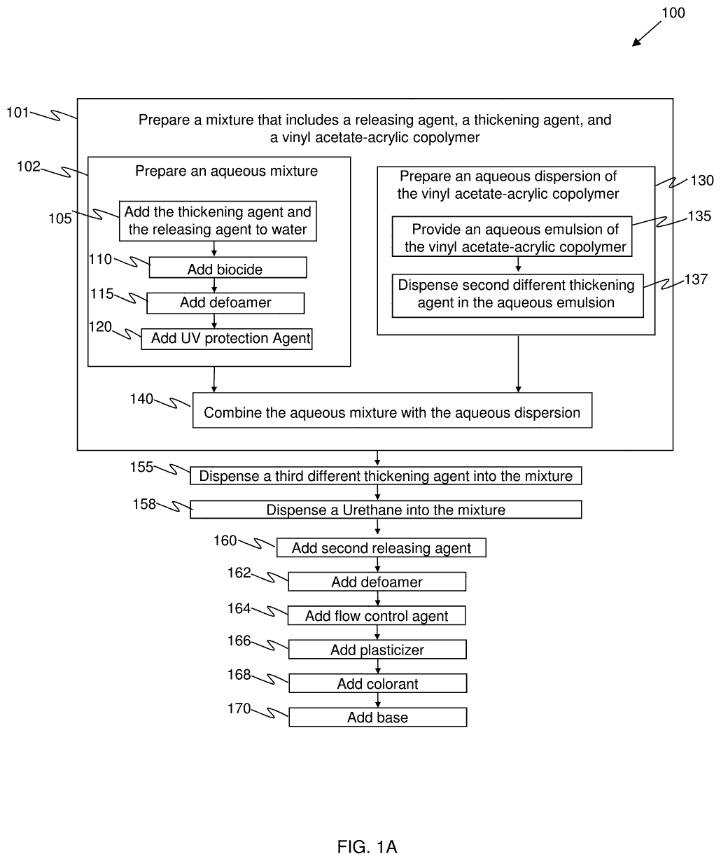

One embodiment of the disclosure is a method of preparing a coating composition which comprises mixing a releasing agent, vinyl acetate-acrylic copolymer, thickening agent and an urethane together in a water base. FIG. 1 presents a flow diagram of an example method of preparing a coating composition of the disclosure.

Some embodiments of method 100 include preparing an aqueous mixture (step 102). In one embodiment, preparing the aqueous mixture includes adding, in a first mixing chamber, water, a first thickening agent and releasing agent (step 105), a biocide (step 110), a defoamer (step 115), and a UV protection agent (step 120). In some embodiments, these components are added in the order presented herein and one or more of the biocide, defoamer, and UV protection agent are optional.

In step 102, about 45 lbs. to about 55 lbs. of water is added to the first mixing chamber, and in one embodiment, about 50 lbs. of water is added. The first thickening agent (e.g., a viscosity building agent) is added in step 105 to the water. The first thickening agent may include Poly(ethylene oxide). The amount of the thickening agent may range from about 7 lbs. to about 10 lbs., and in some embodiments, may be about 8 lbs. Some embodiments of the thickening agent are commercially available from the Dow Chemical Company under the tradename of POLYOX™ WSR N80. The thickening agent, such as Poly(ethylene oxide), may also function as a releasing agent in that it facilitates the easy removal of the film from the coating composition. For instance, the film can be stripped from a product surface in a single step without leaving substantial amounts of the film behind on the surface that have to be removed in additional removal steps.

The optional biocide, which may be added in step 110, can include, hexahyrdo-1,3-,5-tris)2-hydroxyethyl)-s-triazine, one commercially available example of which, may be obtained from the TROY Chemical Corporation, N.J. under the tradename MERGAL® 17411 in amounts ranging from about 1 to 1.5 lbs., and in some cases about 1.34 lbs. In one embodiment, a defoamer is added in step 115 and includes a petroleum hydrocarbon-based foam control agent in amounts ranging from about 1 lbs. to about 3 lbs., and in some cases about 2 lbs. Some embodiments of the defoamer are commercially available from RHODIA, INC, CRANBURY, N.J. under the tradename of RHODOLINE 643. In certain embodiments, the UV protection agent is added in step 120 in an amount ranging from about 2 to about 3 lbs., and in some cases about 2.5 lbs. Some embodiments of the UV protection agent are commercially available from the CIBA CORPORATION, Tanytown, N.Y. under the tradename of TINUVIN 1130.

The method 100 also comprises a step 130 of preparing, in a second mixing chamber, an aqueous dispersion of vinyl acetate-acrylic copolymer, which includes a step 135 of providing a vinyl acetate-acrylic copolymer and a step 137 of adding a second thickening agent (e.g., a different viscosity building agent) to the vinyl acetate-acrylic copolymer.

In some embodiments of step 135, the aqueous dispersion comprises a vinyl acetate-acrylic copolymer, wherein the weight of vinyl acetate-acrylic copolymer ranges from about 600 lbs. to about 740 lbs. In more specific embodiments, the amount of acetate-acrylic copolymer may be about 583 lbs., about 619 lbs., about 656 lbs., or about 692 lbs. One embodiment of the acetate-acrylic copolymer is commercially available from under the a tradename of AVICOR® 325, a product of Celanese Emulsion Polymer, Dallas, Tex. or PERMAFLEX 325 from Southern Resins, Thomasville, N.C. Additionally, in some embodiments, in step 137, a second thickening agent, such as a mixture of acrylate ester and methacrylic acid, is provided in an amount ranging from about 8 lbs. to about 16 lbs., and in one embodiment, the amount of the second thickening agent is about 10 lbs. The total weight of the aqueous dispersion mixture may range from about 600 lbs. to about 700 lbs., and in more specific embodiments, the total weight of the aqueous dispersion mixture may be 600 lbs., one embodiment of this second thickening agent is commercially available from the ROHM and HAAS COMPANY, Philadelphia under the tradename of ACRYSOL™ ASE-60 Thickener. The second thickening agent is gradually mixed into the aqueous dispersion of vinyl acetate-acrylic copolymer until a smooth mixture is obtained.

The method 100 also comprises a step 140 of mixing the aqueous mixture (prepared in step 102) and the aqueous dispersion of vinyl acetate-acrylic copolymer (prepared in step 130) together. For example, in some embodiments, in step 140, one of the above-described embodiments of the aqueous mixture is poured from the first mixing chamber into the second mixing chamber, which contains one of the above-described embodiments of the aqueous dispersion of vinyl acetate-acrylic copolymer.

Some embodiments of the method 100 also comprise a step 150 of using a third thickening agent (e.g., another building agent having a different viscosity). In some embodiments, preparing the third thickening agent in step 150 includes polyacrylate, provided in an amount ranging from about 10 lbs. to about 14 lbs., and in some cases about 11 lbs. Embodiments of this third thickening agent are commercially available from Dow Chemical under the tradename of Acrysol 8306. The third thickening agent is mixed with about 10 lbs. to about 14 lbs. of water, and in some cases about 12 lbs. of water, until the thickening agent is uniformly dispersed in the water and a smooth mixture is obtained.

In addition to the third thickening agent, a urethane, in step 153, is added to the mixture in amount that ranges from about 36 lbs., to about 146 lbs. Depending on the embodiment, the amount urethane may be about 36.5 lbs., 73 lbs., 109.4 lbs. or 145.8 lbs., with the weight of the completed coating composition ranging from about 907 lbs. to about 916 lbs.

In some embodiments, the urethane may comprise a polyurethane polymer, and in some embodiments, is commercially available from UNION SPECIALTIES, INC. Newburyport, Mass. under the tradename UNITHANE HS-1007.

Some embodiments of the method 100 also comprise a step 155 of adding the thickening agent (e.g., such as prepared in step 150) to the mixture of the aqueous mixture and aqueous dispersion of vinyl acetate-acrylic copolymer (e.g., such as prepared in step 130) to complete the preparation of the coating composition.

Some embodiments of the method 100, further include adding and mixing additional components into the coating composition prepared in step 155. These steps can include adding to coating composition, a releasing agent (step 160), a defoamer (step 162), flow control agent (step 164), a plasticizer (step 166), a colorant (step 168) and a base (step 170). In some embodiments, these components are added in the order presented herein. In some embodiments, one or more of the these additional components are optional.

For example, in some cases, step 160 includes adding from about 1 to about 3 lbs., and in some cases, about 2 lb of STRODEX® PK-90 PHOSPHATE ESTER SURFACTANT to the coating composition. In some cases, step 162 also includes adding a defoamer that includes petroleum hydrocarbon-based foam control agents and is provided in an amount ranging from about 1 lbs. to about 3 lbs., and in some cases, about 2 lbs. In yet other embodiments, step 164 includes adding the flow control agent that is provided in an amount ranging from about 2 lbs. to about 4 lbs., and in some cases, about 3.25 lbs. and that comprises ethylene glycol (commercially available from NEXEO SOLUTIONS, Columbus, Ohio). Yet in other embodiments, step 166 includes adding a plasticizer in an amount of about 20 lbs. and may be a combination of ethylene glycol and dipropylene glycol dibenzoate. A step 168 may also include adding a colorant that includes titanium dioxide in an amount of about 17 lbs. Step 168 may also include adding ammonia hydroxide in an amount of about 3 lbs. or an amount that gives the coating composition a basic pH and in some cases, a pH of about 9.

FIG. 1A present another flow diagram of various aspects of embodiments of the method 100 of preparing a coating composition. The method 100 comprises step 101 of preparing a mixture (101) that includes a releasing agent, a thickening agent, and a vinyl acetate-acrylic copolymer. In some embodiments, preparing the mixture (step 101) includes a step 102 of preparing an aqueous mixture.

In some embodiments preparing the aqueous mixture (step 102) includes a step 105 of adding the thickening agent and the releasing agent to water. In some cases, the thickening agent has a different chemical composition than the releasing agent, e.g., one or both of the second or third thickening agents disclosed herein. In some cases, the thickening agent is also the releasing agent, thereby reducing material costs. For instance, in some such cases as part of step 105, the thickening agent and the releasing agent include poly(ethylene oxide). In some embodiments, the thickening agent and the releasing agent are both provided in a concentration range equivalent to about 10 lbs. per about 50 lbs. of water.

In some embodiments, preparing the aqueous mixture (step 102) further includes adding one or more additional components to the aqueous mixture formed in step 105.

For instance, in some embodiments, preparing the aqueous mixture (step 102) further includes a step 110 of adding a biocide, hexahyrdo-1,3-,5-tris)2-hydroxyethyl)-s-triazine, in an amount ranging from about 1 lbs. to about 1.5 lbs. in the aqueous mixture.

For instance, in some embodiments, preparing the aqueous mixture (step 102) further includes a step 115 of adding a defoamer that includes a petroleum hydrocarbon-based foam control agent in a concentration corresponding to about 1 to 1.5 lbs. in the aqueous mixture. For instance, in some embodiments, preparing the aqueous mixture (step 102) further includes a step 120 of adding a UV protection agent in a concentration range corresponding to about 2 to about 3 lbs. in the aqueous mixture. In some such embodiments, the UV protection agent can include one or both of Poly(oxy-1,2-ethanediyl),α-[3-[3-(2H-benzotriazol-2-yl)-5-(1,1-dimethylethyl)-4-hydroxyphenyl]-1-oxopropyl]-Q-[3-[3-(2H-benzotriazol-2-yl)-5-(1,1-dimethylethyl)-4-hydroxyphenyl]-1-oxopropoxy]- (e.g., CAS 104810-47-1, 30-60 wt %) and Poly(oxy-1,2-ethanediyl),α-[3-[3-(2H-benzotriazol-2-yl)-5-(1,1-dimethylethyl)-4-hydroxyphenyl]-1-oxopropyl]-92-hydroxy (e.g., CAS 104810-48-2, 30-60 wt %).

In some embodiments preparing the mixture (step 101) includes a step 130 of preparing an aqueous dispersion of the vinyl acetate-acrylic copolymer. In some cases preparing the aqueous dispersion (step 130) includes a step 135 of providing an aqueous emulsion of the vinyl acetate-acrylic copolymer. In some such embodiments, the aqueous emulsion includes about 50 to about 60 wt % of a vinyl acetate-acrylic copolymer, about 1.5 to about 5 wt % of a surfactant, about 0.5 to about 1 wt % of a vinyl acetate monomer, and balance water.

In some embodiments, preparing the aqueous dispersion (step 130) further includes a step 137 of dispersing a second different thickening agent in the aqueous emulsion. In some such embodiments the second thickening agent includes a combination of acrylate ester and methacrylic acid. In some embodiments, the concentration of the added combination of acrylate ester and methacrylic acid is equivalent to about 8 to about 16 lbs. acrylate ester and methacrylic acid in about 700 to about 800 of the aqueous emulsion.

In some embodiments, preparing the mixture (step 101) includes a step 140 of combining the aqueous mixture, having at least the thickening agent and the releasing agent (e.g., the aqueous mixture after step 102, but in some cases after any or all of steps 110-120), with the aqueous dispersion (e.g., the aqueous dispersion after step 130, but in some cases after any or all of steps 135-137). In some cases in step 140, the aqueous mixture is added to the aqueous dispersion. In some such embodiments, the weight ratio of the aqueous mixture to the aqueous dispersion is about 65 lbs. of the aqueous mixture to about 600 lbs.to about 700 lbs. of the aqueous dispersion.

In some embodiments, the method 100 further includes a step 155 dispensing a third different thickening agent into the mixture (step 101, e.g., in some cases, the aqueous mixture plus the aqueous dispersion prepared in step 140) and a urethane in step 158. In some such embodiments, the third thickening agent includes polyacrylate in an amount of about 11 lbs. with the urethane being present in an amount ranging from about 36 lbs. to about 145 lbs.

In some embodiments, the method 100 further includes dispersing, into the mixture (step 101, and in some cases, the the aqueous mixture plus the aqueous dispersion prepared in step 140), one or more of additional components.

For instance, in some embodiments, the method 100 further includes a step 160 of adding a second releasing agent to the mixture of the aqueous mixture plus the aqueous dispersion (step 140). In some such embodiments, the second releasing agent includes a phosphate ester salt in an amount ranging from about 1 lbs. to about 3 lbs. in a total weight of the mixture of the aqueous mixture plus the aqueous dispersion.

For instance, in some embodiments, the method 100 further includes a step 162 of adding a defoamer to the mixture of the aqueous mixture plus the aqueous dispersion (step 140). In some such embodiments, the defoamer includes a petroleum hydrocarbon-based foam control agents in an amount ranging from about 1 lbs. to about 3 lbs. in the total weight of the mixture of the aqueous mixture plus the aqueous dispersion.

For instance, in some embodiments, the method 100 further includes a step 164 of adding a flow control agent to the mixture of the aqueous mixture plus the aqueous dispersion (step 140). In some such embodiments,

For instance, in some embodiments, the method 100 further includes a step 166 of adding a plasticizer to the mixture of the aqueous mixture plus the aqueous dispersion (step 140). In some such embodiments, the flow control agent includes ethylene glycol in an amount ranging from about 2 lbs. to about 4 lbs. in the total weight of the mixture of the aqueous mixture plus the aqueous dispersion.

For instance, in some embodiments, the method 100 further includes a step 168 of adding a colorant to the mixture of the aqueous mixture plus the aqueous dispersion (step 140). In some such embodiments, the plasticizer includes dipropylene glycol dibenzoate in an amount ranging from about 5 lbs. to about 14 lbs. in the total weight of the mixture of the aqueous mixture plus the aqueous dispersion.

For instance, in some embodiments, the method 100 further includes a step 170 of adding a base to the mixture of the aqueous mixture plus the aqueous dispersion (step 140). In some such embodiments, the base includes ammonia hydroxide in an amount ranging from about 2 lbs. to about 4 lbs. of an about 19 to 30 wt % aqueous ammonia hydroxide solution in the total weight of the mixture of the aqueous mixture plus the aqueous dispersion. The base is provided in sufficient amounts so as to provide the aqueous mixture plus the aqueous dispersion with a pH of greater than 7.

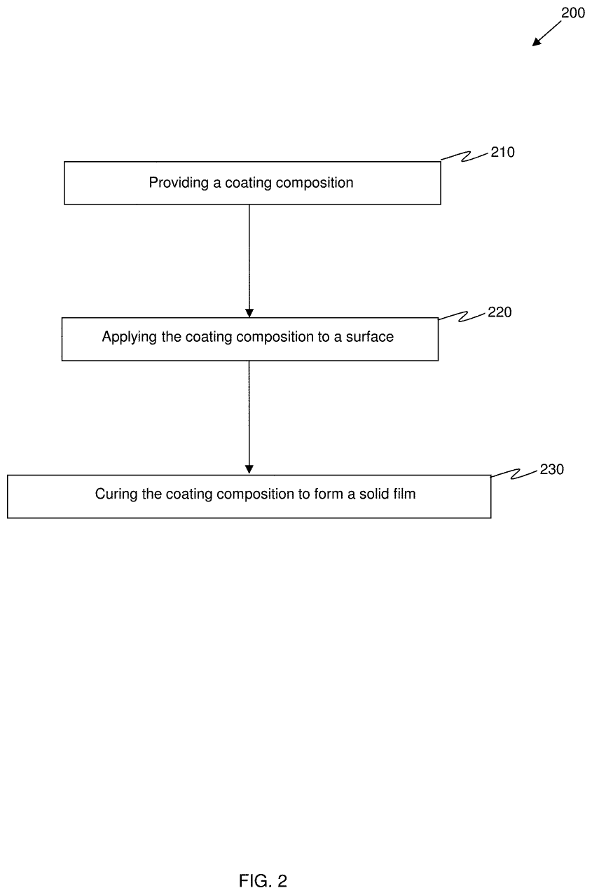

Another embodiment is forming a film of the coating composition. FIG. 2 presents a flow diagram of an example method 200 of forming a film of the disclosure, such a film formed from any of the coating compositions formed from the example method described in the content of FIG. 1.

As illustrated in FIG. 2, the method 200 includes a step 210 of providing a coating composition, such as any of the above-described coating compositions formed by one or more embodiments the method 100 as discussed in the context of FIG. 1. The coating composition provided in step 210 has a viscosity value (e.g. dynamic viscosity) in a range from about 102 to about 121 Krebs units (KU), and in some cases, from about 108 to about 110 KU, and in some cases, from about 115 KU to about 118 KU.

All viscosity measures disclosed herein assume the use of a Stormer-type viscometer (e.g., Model No. 9730G45, Thomas Scientific, Swedesboro, N.J.), using a measurement temperature of about 77° F. The viscosity measurements are performed as described in accordance with ASTM D-562, Method for Determination of Consistency of Paint Using the Stormer Viscometer, which is incorporated herein in its entirety.

The method 200 further includes a step 220 of applying the coating composition provided in step 210 to a surface. In some cases, for example, the surface is the surface of a manufactured product such as a vehicle. The step 220 of applying the coating can include, but is not limited, to rolling, brushing, extruding, pouring or otherwise dispensing the coating composition onto the surface, or in some cases, dipping the product into a container holding the coating composition.

Some embodiments of method further include a step 230 of curing the coating composition applied to the surface to form a solid film. In some cases curing the coating composition includes allowing the applied composition air-dry at room temperature for a suitable period commensurate with the thickness of the coating composition applied to the surface. For instance, in some cases an about 20 mils thick layer of the coating composition can air-dry, to human touch, in at least about 1 hr and cure in about 24 hours. In other cases, to speed curing, the coating composition is exposed to an elevated temperature e.g., greater than about 70° F. to 180° F. or to moving air.

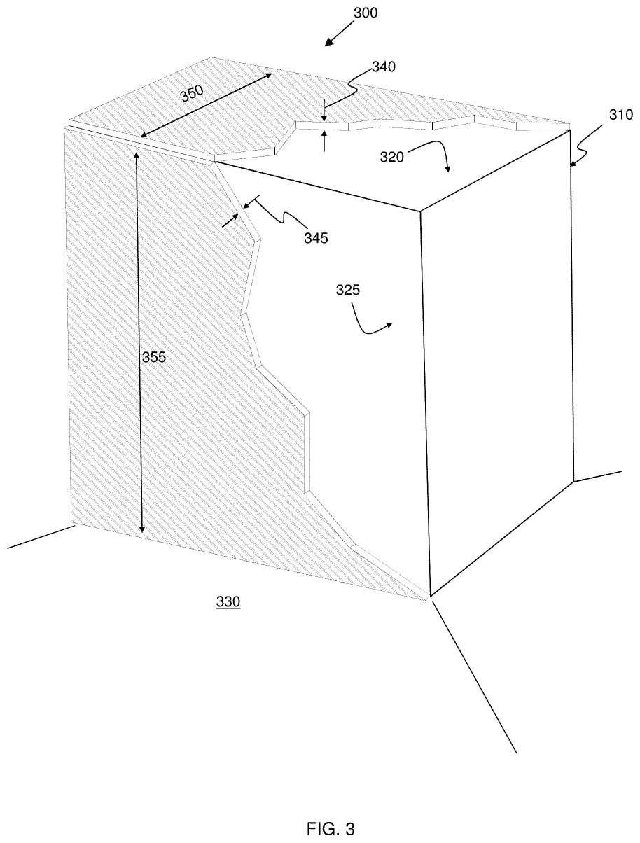

Another embodiment of the present disclosure is a film of the above-described coating composition. FIG. 3 presents a schematic view of an example film 300 of the coating composition, such a film formed by applying any of the example coating compositions or films described in the context of FIGS. 1 and 2, to a product 310.

Temperature tests were conducted on different embodiments at −20° C., 60° C., and at room temperature (approx. 23° C.) of the coating compositions as discussed above, the results of which are shown in Tables I through III as follows:

TABLE I

| | Test | | | | | |
|---|---|---|---|---|---|---|
| | 1 Pass | 1 Pass | 2 Passes | 2 Passes | 3 Passes | 3 Passes |
| | Latitude | Longitude | Latitude | Longitude | Latitude | Longitude |
| | Direction | Direction | Direction | Direction | Direction | Direction |
| | −20° C. | −20° C. | −20° C. | 20° C. | 20° C. | 20° C. |
| | 40 Min | 40 Min | 40 Min | 40 Min. | 40 Min. | 40 Min. |
| Film | 0.0040 in. | 0.0040 in | 0.0090 in. | 0.0090 in. | 0.0140 in. | 0.0140 in. |
| Thickness | | | | | | |
| Tensile | 114 | 63 | 416 | 403 | 168 | 168 |
| PSI | | | | | | |
| Elongation % | 677 | 368 | 1006 | 903 | 1090 | 1086 |
| Force | 0.52 | 0.29 | 3.74 | 3.87 | 2.35 | 2.38 |
| LbF | | | | | | |

TABLE II

| | Test | | | | | |
|---|---|---|---|---|---|---|
| | 1 Pass | 1 Pass | 2 Passes | 2 Passes | 3 Passes | 3 Passes |
| | Latitude | Longitude | Latitude | Longitude | Latitude | Longitude |
| | Direction | Direction | Direction | Direction | Direction | Direction |
| | 60° C. | 60° C. | 60° C. | 60° C. | 60° C. | 60° C. |
| | 20 Min | 20 Min | 20 Min | 20 Min. | 20 Min. | 20 Min. |
| Film | 0.0045 in. | 0.0045 in | 0.0090 in. | 0.0090 in. | 0.0140 in. | 0.0140 in. |
| Thickness | | | | | | |
| Tensile | 48 | 53.7 | 359 | 330 | 268 | 262 |
| PSI | | | | | | |
| Elongation % | 702 | 849 | 820 | 880 | 1020 | 976 |
| Force | 0.22 | 0.24 | 3.23 | 2.97 | 3.75 | 3.66 |
| LbF | | | | | | |

TABLE III

| | Test | | | | | |
|---|---|---|---|---|---|---|
| | 1 Pass | 1 Pass | 2 Passes | 2 Passes | 3 Passes | 3 Passes |
| | Latitude | Longitude | Latitude | Longitude | Latitude | Longitude |
| | Direction | Direction | Direction | Direction | Direction | Direction |
| | Room Temp | Room Temp | Room Temp | Room Temp | Room Temp | Room Temp |
| Film | 0.0045 in. | 0.0045 in | 0.0090 in. | 0.0090 in. | 0.0140 in. | 0.0140 in. |
| Thickness | | | | | | |
| Tensile | 72.3 | 44.2 | 359 | 330 | 268 | 262 |
| PSI | | | | | | |
| Elongation % | 746 | 323 | 820 | 880 | 1020 | 976 |
| Force | 0.35 | 0.20 | 3.23 | 2.97 | 3.75 | 3.66 |
| LbF | | | | | | |

As illustrated in FIG. 3, in some embodiments the film 300 is uniformly applied regardless of whether the film 300 is applied to a horizontal surface 320 or vertical surface 325 (e.g., surfaces substantially horizontal and perpendicular to the earth's surface 330, respectively. For instance, in some embodiments the thickness 340 of the layer 300 applied to a horizontal surface 320 and the thickness 345 of the layer 300 applied to a vertical surface 325 are the same within about 20 percent and more preferably within about 10 percent and even more preferably within about 5 percent. For instance, in some embodiments the thickness 340 of the layer 300 applied to along an entire horizontal dimension 350 of the product surface 320 is the same within about 20 percent and more preferably within about 10 percent and even more preferably within about 5 percent. For instance, in some embodiments the thickness 345 of the layer 300 applied to along an entire vertical dimension 355 of the product surface 320 is the same within about 20 percent and more preferably within about 10 percent and even more preferably within about 5 percent

One of ordinary skill in the pertinent art would understand how the percentage dry weight compositions of the various components in the layer 300 would change as compared to the coating composition, e.g., based on the amount of volatile components (e.g., water and volatile organic compounds) that are removed during a curing step 230. For instance, consider a coating applied with a thickness in a range of about 6 to 20 mils, which upon curing, forming into a dried film layer with about one-half of that thickness (e.g., thickness 340, 345) of about 3 to 10 mils, respectively. One of ordinary skill would be able to determine the weight of lost volatile compounds and estimate the weight percent compositions of the non-volatile compounds remaining in the layer 300.

Based upon various embodiments of the method discussed in the context of FIG. 1-2, in some cases, the film of the coating composition includes a releasing agent, a thickening agent, a vinyl acetate-acrylic copolymer and a urethane that provides a film that retains useful flexibility and lower temperatures.

Although the present invention has been described in detail, one of ordinary skill in the pertinent art should understand that they can make various changes, substitutions and alterations herein without departing from the scope of the invention.

What is claimed is:

1. A method of preparing a coating composition, comprising:
preparing in a first mixing chamber an aqueous mixture of water, wherein a weight of the water ranges from about 45 lbs. to about 55 lbs. and a first thickening/releasing agent of poly(ethylene oxide), wherein a weight concentration of the first thickening-releasing agent ranges from about 7 lbs. to about 10 lbs.;
preparing an aqueous dispersion mixture of vinyl acetate-acrylic copolymer in a second mixing chamber, including adding a second thickening agent of a mixture of acrylate ester and methacrylic acid mixture to the aqueous dispersion mixture, wherein a weight of the second thickening agent ranges from about 8 to about 16 lbs.;
combining the aqueous mixture to the aqueous dispersion mixture to prepare a coating mixture;
adding a third thickening agent of polyacrylate to the coating mixture, wherein a concentration of the third thickening agent ranges from about 11 lbs. to about 13 lbs. and water is further added in an amount ranging from about 10 to about 14 lbs., wherein the first, second, and third thickening agents have different viscosities; and
adding a urethane to the coating mixture in amount ranging from about 36 lbs. to about 146 lbs.

2. The method of claim 1, wherein the urethane comprises polyurethane polymer.

3. The method of claim 1, further including adding a releasing agent to the coating composition.

4. The method of claim 1, wherein the amount of vinyl acetate-acrylic copolymer is about 583 lbs. and the amount of urethane is about 145 lbs.

5. The method of claim 1, wherein the amount of vinyl acetate-acrylic copolymer is about 619 lbs. and the amount of urethan is about 109 lbs.

6. The method of claim 1, wherein preparing the coating mixture includes combining the aqueous mixture with the aqueous dispersion mixture, such that a weight ratio of the aqueous mixture to the aqueous dispersion mixture is equivalent to a range of about 70 to about 90 lbs. of the aqueous mixture to about 700 to about 900 lbs. of the aqueous dispersion mixture.

7. The method of claim 1, further including dispersing, into the coating mixture, one or more of additional components of:
a defoamer;
a flow control agent;
a plasticizer;
a colorant; and
a base.

8. The method of claim 7, wherein the additional components include one or more of:
the defoamer includes a petroleum hydrocarbon-based foam control agents in an amount ranging from about 1 lbs. to about 3 lbs. in the total weight of the mixture of the aqueous mixture plus the aqueous dispersion;
the flow control agent includes ethylene glycol in an amount ranging from about 2 lbs. to about 4 lbs. in the total weight of the mixture of the aqueous mixture plus the aqueous dispersion;
the plasticizer includes dipropylene glycol dibenzoate in an amount ranging from about 5 lbs. to about 14 lbs. in the total weight of the mixture of the aqueous mixture plus the aqueous dispersion;
the colorant includes titanium dioxide in an amount ranging from about 1 lbs. to about 3 lbs. in the total weight of the mixture of the aqueous mixture plus the aqueous dispersion; or
the base includes ammonia hydroxide in an amount ranging from to about 2 lbs. to about 4 lbs. of an about 19 to 30 wt % aqueous ammonia hydroxide solution in the total weight of the mixture of the aqueous mixture plus the aqueous dispersion, so as to provide the aqueous mixture plus the aqueous dispersion with a pH of greater than 7.

9. A protective coating mixture, comprising:
an aqueous mixture of water and a first thickening/releasing agent of poly(ethylene oxide), wherein a concentration of the first thickening/releasing agent ranges from about 7 to about 10 lbs. per about 65 to about 70 lbs. of water;
an aqueous dispersion mixture of vinyl acetate-acrylic copolymer, including a second thickening agent of a mixture of acrylate ester and methacrylic acid mixture, wherein a concentration of the second thickening agent ranges from about 8 to about 16 lbs. in about 700 to about 800 lbs. of the aqueous dispersion mixture;
a third thickening agent of polyacrylate, wherein a concentration of the third thickening agent ranges from about 4 lbs. to about 12 lbs. of the polyacrylate to about 20 to about 25 lbs. of water; and
a second releasing agent of phosphate ester salt.

10. The coating mixture of claim 9, wherein the first, second, and third thickening agents have different viscosities.

11. The coating mixture of claim 9, further comprising a biocide, defoamer, and an ultraviolet light protection agent to the aqueous mixture.

12. The coating mixture of claim 9, wherein the phosphate ester salt of the second releasing agent has an amount ranging from about 1 lbs. to about 3 lbs. in a total weight of the coating mixture.

13. The coating mixture of claim 12, wherein the biocide comprises;
hexahyrdo-1,3-,5-tris)2-hydroxyethyl)-s-triazine in an amount ranging from about 1 lbs. to about 1.5 lbs. in the aqueous mixture;
the defoamer includes petroleum hydrocarbon-based foam control agent in a concentration corresponding to about 1 to 1.5 lbs. in the aqueous mixture; and
the UV protection agent is present in a concentration range corresponding to about 2 to about 3 lbs. in the aqueous mixture, and including one or both of: Poly(oxy-1,2-ethanediyl),W-[3-[3-(2H-benzotriazol-2-yl)-5-(1,1-dimethylethyl)-4-hydroxyphenyl]-1-oxopropyl]-Ω-[3-[3-(2H-benzotriazol-2-yl)-5-(1,1-dimethylethyl)-4-hydroxyphenyl]-1-oxopropoxy]-; and Poly(oxy-1,2-ethanediyl),α-[3-[3-(2H-benzotriazol-2-yl)-5-(1,1-dimethylethyl)-4-hydroxyphenyl]-1-oxopropyl]-Ω-hydroxy.

14. The coating mixture of claim 9, wherein the aqueous dispersion mixture includes an aqueous emulsion that includes:
about 50 to about 60 wt % of a vinyl acetate-acrylic copolymer,
about 1.5 to about 5 wt % of a surfactant,
about 0.5 to about 1 wt % of a vinyl acetate monomer, and
the balance of the aqueous emulsion being water.

15. The coating mixture of claim 9, wherein the coating mixture includes a combination of the aqueous mixture with the aqueous dispersion mixture, such that a weight ratio of the aqueous mixture to the aqueous dispersion mixture is equivalent to a range of about 70 to about 90 lbs. of the aqueous mixture to about 700 to about 900 lbs. of the aqueous dispersion mixture.

16. The coating mixture of claim 9, further including one or more of additional components of:
a defoamer;
a flow control agent;
a plasticizer;
a colorant; or
a base.

17. The coating mixture of claim 16, wherein the additional components include one or more of:
the defoamer includes a petroleum hydrocarbon-based foam control agents in an amount ranging from about 1 lbs. to about 3 lbs. in the total weight of the mixture of the aqueous mixture plus the aqueous dispersion;
the flow control agent includes ethylene glycol in an amount ranging from about 2 lbs. to about 4 lbs. in the total weight of the mixture of the aqueous mixture plus the aqueous dispersion;
the plasticizer includes dipropylene glycol dibenzoate present in an amount ranging from about 5 lbs. to about 14 lbs. in the total weight of the mixture of the aqueous mixture plus the aqueous dispersion;
the colorant includes titanium dioxide in an amount ranging from about 1 lbs. to about 3 lbs. in the total weight of the mixture of the aqueous mixture plus the aqueous dispersion; or
the base includes ammonia hydroxide in an amount ranging from about 2 lbs. to about 4 lbs. of an about 19 to 30 wt % aqueous ammonia hydroxide solution in the total weight of the mixture of the aqueous mixture plus the aqueous dispersion, so as to provide the aqueous mixture plus the aqueous dispersion with a pH of greater than 7.

18. A protective coating mixture, comprising:
an aqueous mixture of water and a first thickening/releasing agent of poly(ethylene oxide);
an aqueous dispersion mixture of vinyl acetate-acrylic copolymer, including a second thickening agent of a mixture of acrylate ester and methacrylic acid mixture;
a third thickening agent of polyacrylate; and
a second releasing agent of phosphate ester salt.

19. The coating of claim 18, wherein a concentration of the first thickening/releasing agent ranges from about 7 to about 10 lbs. per about 65 to about 70 lbs. of water.

20. The coating of claim 18, wherein a concentration of the second thickening agent ranges from about 8 to about 16 lbs. in about 700 to about 800 lbs. of the aqueous dispersion mixture.

21. The coating of claim 18, wherein a concentration of the third thickening agent ranges from about 4 lbs. to about 12 lbs. of the polyacrylate to about 20 to about 25 lbs. of water.

22. The coating mixture of claim 19, wherein the first, second, and third thickening agents have different viscosities.

23. The coating mixture of claim 19, further comprising a biocide, defoamer, and an ultraviolet light protection agent to the aqueous mixture.

24. The coating mixture of claim 19, wherein the phosphate ester salt of the second releasing agent has an amount ranging from about 1 lbs. to about 3 lbs. in a total weight of the coating mixture.

25. The coating mixture of claim 23, wherein the biocide comprises hexahyrdo-1,3-,5-tris)2-hydroxyethyl)-s-triazine in an amount ranging from about 1 lbs. to about 1.5 lbs. in the aqueous mixture;
the defoamer includes petroleum hydrocarbon-based foam control agent in a concentration corresponding to about 1 to 1.5 lbs. in the aqueous mixture; and
the UV protection agent is present in a concentration range corresponding to about 2 to about 3 lbs. in the aqueous mixture, and including one or both of:
Poly(oxy-1,2-ethanediyl),α-[3-[3-(2H-benzotriazol-2-yl)-5-(1,1-dimethylethyl)-4-hydroxyphenyl]-1-oxopropyl]-Ω-[3-[3-(2H-benzotriazol-2-yl)-5-(1,1-dimethylethyl)-4-hydroxyphenyl]-1-oxopropoxy]-; and
Poly(oxy-1,2-ethanediyl),α-[3-[3-(2H-benzotriazol-2-yl)-5-(1,1-dimethylethyl)-4-hydroxyphenyl]-1-oxopropyl]-Ω-hydroxy.

26. The coating mixture of claim 19, wherein the aqueous dispersion mixture includes an aqueous emulsion that includes:
about 50 to about 60 wt % of a vinyl acetate-acrylic copolymer,
about 1.5 to about 5 wt % of a surfactant,
about 0.5 to about 1 wt % of a vinyl acetate monomer, and
the balance of the aqueous emulsion being water.

27. The coating mixture of claim 19, wherein the coating mixture includes a combination of the aqueous mixture with the aqueous dispersion mixture, such that a weight ratio of the aqueous mixture to the aqueous dispersion mixture is equivalent to a range of about 70 to about 90 lbs. of the aqueous mixture to about 700 to about 900 lbs. of the aqueous dispersion mixture.

28. The coating mixture of claim 19, further including one or more of additional components of:
a defoamer, wherein the defoamer includes a petroleum hydrocarbon-based foam control agents in an amount ranging from about 1 lbs. to about 3 lbs. in the total weight of the mixture of the aqueous mixture plus the aqueous dispersion;
a flow control agent, wherein the flow control agent includes ethylene glycol in an amount ranging from about 2 lbs. to about 4 lbs. in the total weight of the mixture of the aqueous mixture plus the aqueous dispersion;
a plasticizer, wherein the plasticizer includes dipropylene glycol dibenzoate in an amount ranging from about 5 lbs. to about 14 lbs. in the total weight of the mixture of the aqueous mixture plus the aqueous dispersion;
a colorant, wherein the colorant includes titanium dioxide in an amount ranging from about 1 lbs. to about 3 lbs. in the total weight of the mixture of the aqueous mixture plus the aqueous dispersion; or
a base, wherein the bases includes ammonia hydroxide in an amount ranging from about 2 lbs. to about 4 lbs. of an about 19 to 30 wt % aqueous ammonia hydroxide solution in the total weight of the mixture of the aqueous mixture plus the aqueous dispersion, so as to provide the aqueous mixture plus the aqueous dispersion with a pH of greater than 7.
